(19) United States
(12) Patent Application Publication
(10) Pub. No.: US 2019/0108816 A1
(43) Pub. Date: Apr. 11, 2019

(54) Information Handling System Optical Narrow Bezel

(71) Applicant: Dell Products L.P., Round Rock, TX (US)

(72) Inventors: Stefan Peana, Austin, TX (US); Deeder M. Aurongzeb, Austin, TX (US)

(73) Assignee: Dell Products L.P., Round Rock, TX (US)

(21) Appl. No.: 15/728,804

(22) Filed: Oct. 10, 2017

(51) Int. Cl. G09G 5/36; G02B 3/00; G06F 1/16

(52) U.S. Cl. CPC G09G 5/363; G02B 3/0006; G06F 1/1637; G06F 1/1626; G09G 2340/14; G09G 2340/02; G09G 2300/0465; G09G 2320/028; G06F 1/1698

(57) ABSTRACT

An information handling system display presents visual images that extend over a bezel disposed about the display perimeter. A first lens structure integrated in a cover placed over the display redirects light from proceeding out of the cover over the display to instead proceed towards the bezel. A second lens structure integrated in the cover placed over the bezel redirects light proceeding from the first lens structure to proceed out of the cover over the bezel.

### BACKGROUND OF THE INVENTION

### Field of the Invention

The present invention relates in general to the field of information handling system displays, and more particularly to an information handling system optical narrow bezel.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems typically include an integrated flat panel display, such as a liquid crystal display (LCD) or an organic light emitting diode (OLED) display. Generally, the dimensions of the display define the size of the information handling system. For example, tablet information handling systems have a flat panel display integrated on one side of a planar housing that covers processing components disposed within the planar housing. End users tend to select tablet information handling systems for the size of display, which generally relates to the portability of the display. Mobile telephones, for instance, tend to have smaller display areas so that the housing will readily fit into a pocket or handbag. Larger tablets have greater screen size so that reading from the tablets is more convenient, however, larger tablets tend to be less portable. In addition to tablet information handling systems, other types of portable information handling systems include integrated displays. For example, convertible information handling systems typically include touchscreen displays integrated in a housing lid that rotates relative to a housing that, in turn, integrates a keyboard. As with tablet information handling systems, convertible information handling systems tend to have their dimensions driven by the size of the display integrated into the housing.

When flat panel displays are assembled into a housing, some structure typically is included along the outer edge of the display to couple the display to the housing. The structure typically includes a bezel placed about the perimeter of the display that blends the display presentation with the housing edge. In many instances, the bezel is apparent to a viewer of the display as a rectangular black zone disposed about the perimeter of the display. In some instances, the display presentation is extended outwards towards the bezel by adapting a transparent cover layer placed over the display so that it provides display output over the bezel. For example, a transparent cover layer is tapered along its edge so that the image presented at the display is shifted laterally in order to present a continuous image across a bezel area. For effective presentation of an image over a bezel area, the cover layer is machined or formed to shift the light over the bezel without distorting the image. In order to achieve an acceptable image presentation, the outer edge of the transparent cover has a curved lens or angled chamfer shape that redirects light from the display at an angle and out the edge of the cover. One difficulty with such a cover lens structure is that the thickness of the cover tends to increase so that the desired optical performance is achieved. For example, to provide an effective lens cover shape that diverts image light over a bezel, the cover over the display typically has a height of three times the bezel size so that the lens shape along the edge of the cover has a radius adequate to redirect the image without distortion. As another example, a chamfer shaped cover edge typically has a height of four times the bezel size in order to redirect image light over the bezel. Increased display cover thickness adds to the height and weight of the information handling system, impacting portability and increasing material costs.

### SUMMARY OF THE INVENTION

Therefore, a need has arisen for a system and method which redirects display light to extend a visual image over a bezel with a low profile display protective cover.

In accordance with the present invention, a system and method are provided which substantially reduce the disadvantages and problems associated with previous methods and systems for presenting visual images at a display having a bezel. A lens structure integrated in a display cover redirects light illuminated by the display to extend a visual image beyond the perimeter of the display, such as over a bezel that is disposed about the perimeter of the display.

More specifically, an information handling system processes information with processing components disposed in a housing, such as a processor, memory and graphics processor. Information is presented on a display, such as a flat panel LCD or OLED display, by defining pixel values with the graphics processor. The display perimeter has a bezel that protects the ends of the display from damage and cover wires and structure at the edge of the display. A cover disposed over the display and bezel includes a lens structure that redirects visual images presented by the display to present the visual images over the bezel. The lens structure includes an inner lens located over and proximate the display and an outer lens located over the bezel and distal the display. Light from the display is redirected from the inner to the outer lens so that the visual effect for a viewing end user is to have the entire cover appear to present the visual image instead of having the visual image presented from just the display. An angle correction module executing on a GPU or other processing component creates a compressed visual image along the perimeter of the display so that, as the lens structure redirects light to the bezel, the visual image blends as a whole between what is presented by display 28 and what is redirected to present over bezel 30.

The present invention provides a number of important technical advantages. One example of an important technical advantage is that an image presented at an information handling system display is extended to the edge of a bezel with a lens integrated in a cover disposed over the display and bezel. For example, opposing prism structures integrated proximate the display and the cover outer surface re-direct light output at the display to exit the cover outside the perimeter of the display. The visual effect provided by the redirection of light is to extend the display presentation out over the bezel. The use of separate opposing prism structures provides redirection of visual image light with a generally flat outer cover surface so that cover thickness is reduced and not driven by bezel size. Coordination by a graphics processor with known lens orientation provides presentation of a compressed visual image at the outer perimeter of the display so that the image viewed at the cover surface appears undistorted.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a blown up view of an information handling system having an integrated display and bezel;

FIG. 2 depicts a side view of a display, cover, bezel and micro lens structure that extends a visual image presented at the display over the bezel;

FIG. 3 depicts a ray trace of an example embodiment having opposing prism structures;

FIG. 4 depicts a side view of a display having pixels that present visual images with a compressed relative view that expands to an undistorted view at the outer cover;

FIG. 5 depicts a multilayer lens structure to redirect light from display to extend out over a bezel;

FIG. 6 depicts a side view of a display having a visual image redirected through a first lens to proceed towards a second lens and out of a cover over a bezel with the visual image expanded over the bezel;

FIG. 7 depicts a top view of a display having a bezel with a first lens structure disposed over the display at its perimeter and a second lens structure disposed over the bezel; and

FIG. 8 depicts a side view of the available viewing angles typically found with different types of display technologies.

### DETAILED DESCRIPTION

An information handling system display cover redirects light proceeding from a display to proceed out from the bezel, proving a zero bezel appearance. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

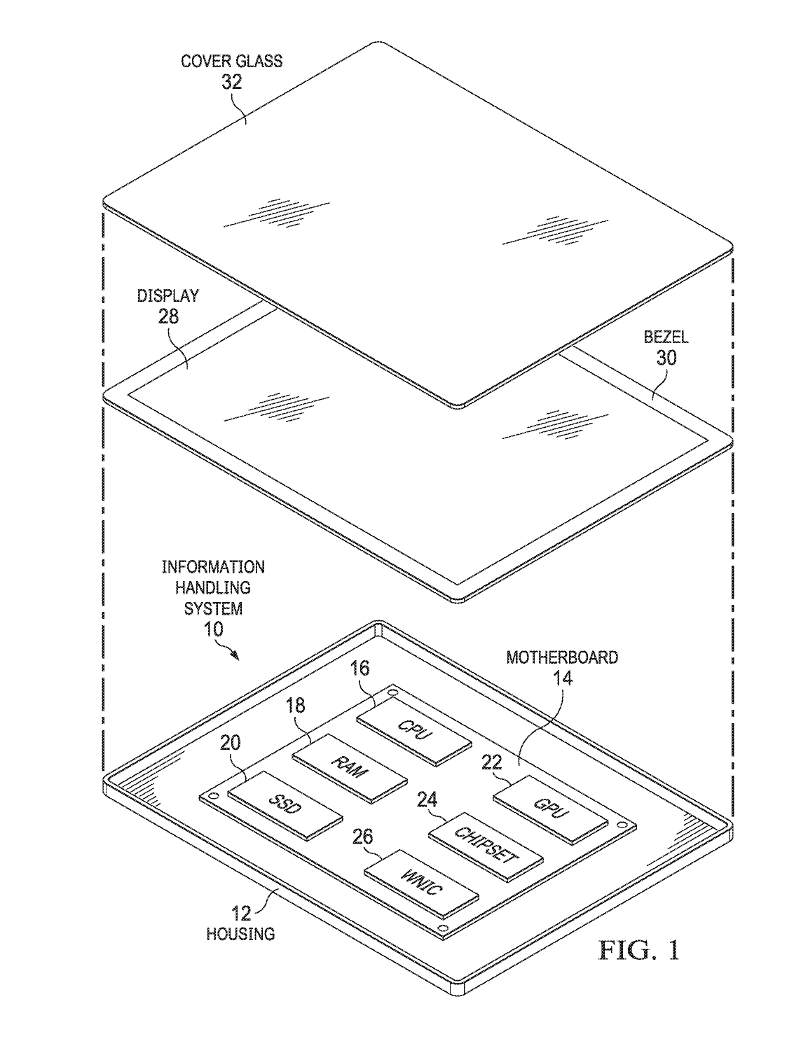

Referring now to FIG. 1, a blown up view depicts an information handling system 10 having an integrated display 28 and bezel 30. Information handling system 10 has a tablet configuration with a planar housing 12 that contains processing components disposed under display 28. In the example embodiment, a motherboard 14 interfaces a central processing unit (CPU) 16 and random access memory (RAM) 18 to execute instructions that process information. A solid state drive (SSD) 20 provides persistent memory that stores information and applications when power is off. A graphics processing unit (GPU) 22 interfaces with CPU 16 to process visual information into pixel values that define a visual image on display 28. A chipset 24 manages interfaces by CPU 16 with hardware and peripheral devices, such as input/output (I/O) devices and power sources. A wireless network interface card (WNIC) 26 provides wireless communication, such as through a wireless local area network (WLAN) or a wireless personal area network (WPAN). In alternative embodiments, various form factors and hardware configurations may be used, such as convertible information handling systems or all-in-ones. In one embodiment, the present disclosure applies to a display peripheral that interfaces with an information handling system to present visual images.

In the example embodiment, bezel 30 couples to housing 12 at the outer perimeter of display 28 to help hide cables and structures disposed at the perimeter of display 28. A cover glass 32 couples over the top of display 28 and bezel 30 to further secure display 28 in place and protect display 28 from damage. Cover glass 32 includes integrated light re-direction structures that extend visual images presented by display 28 to appear over bezel 30. The extended visual images provide a more user-friendly appearance and helps ensure that the entire surface area at the face of information handling system 10 display 28 presents a visual image for more efficient use of the system footprint.

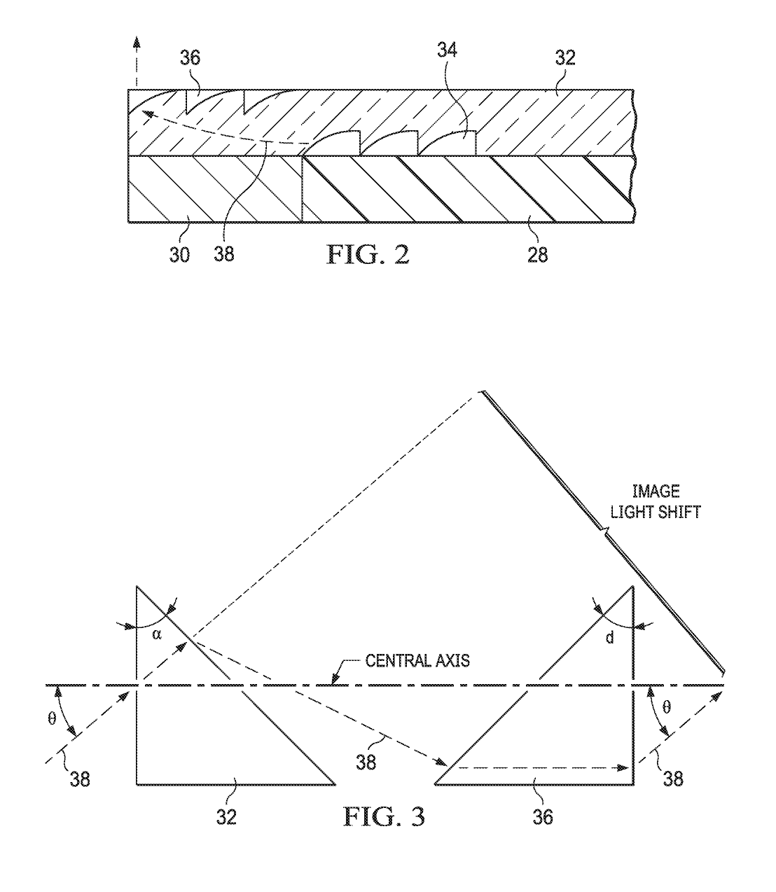

Referring now to FIG. 2, a side view depicts a display 28, cover 32, bezel 30 and micro lens structure 34 and 36 that extends a visual image presented at the display over bezel 30. A first set of inner micro lens 34 are integrated in cover 32 in a location over display 28 at its perimeter where bezel 30 surrounds display 28. A second set of outer micro lens 36 are integrated in cover 32 over top of bezel 30 near the upper surface of cover 32. In the example embodiment, inner and outer micro lens are essentially opposing prisms with curved surfaces that direct light from display 28 to exit offset over the top of bezel 30. A visual image light ray path 38 depicts that light exiting display 28 enters inner micro lens 34 at an angle substantially perpendicular to the plane of display 28 and is redirected to a path substantially parallel to the plane of display 28. Inner micro lens 34 directs the light to corresponding outer micro lens 36 that, in turn, redirects the light to a path substantially perpendicular to the plane of display 28. The effect of the cooperating lens structures is to shift the visual image presented at display 28 along the perimeter of bezel 30 to instead show over bezel 30. Curved edges in the lens structure distribute light in an even manner so that the visual image presented from display 28 to the outer edge of bezel 30 has an undistorted appearance. The lens structure may refract light to accomplish image shift by using materials with different coefficients of diffusion, inserting air within the cover material and adapting the angles of incidence within cover 32. The lens structure supports image shifting to a position over bezel 30 with a generally flat cover 32 shape so that the overall thickness of cover 32 does not increase by forming a lens shape with the cover outer surface. As described herein, visual image light is generated form a display 28 having a generally planar shape. Some curve is sometimes included in a flat panel display and such a display would be included in a description of generally planar. Light proceeding from a. display generally follows a perpendicular path from the display to present a visual image to a user viewing the display. The lens structure 34 and 36 redirects light from a generally perpendicular path to a path that is substantially parallel to the plane of display 28 so that the visual image shifts laterally to a point over the bezel instead of over the display. The relative terms used to describe the light ray path are meant to convey the shifting of an image at a display laterally to a bezel area and are not intended to restrict the disclosure to precise angular relationships.

Referring now to FIG. 3, a ray trace depicts an example embodiment having opposing prism structures to shift light. In the example embodiment, light enters and exits prisms 32 and 36 at the same angle but shifted laterally relative to a central axis of prisms 32 and 36. The path 38 of the light ray is based upon the angle of incidence and relative exit angle defined by prisms 32 and 36. In the example, prisms 32 and 36 have opposing shapes so that light exiting prism 36 has a path 38 parallel to the entry path at prism 32 with the image shifted laterally as depicted. Alternative lens shapes and relative alignments may be used to shift the light ray 38 to a desired relative lateral location.

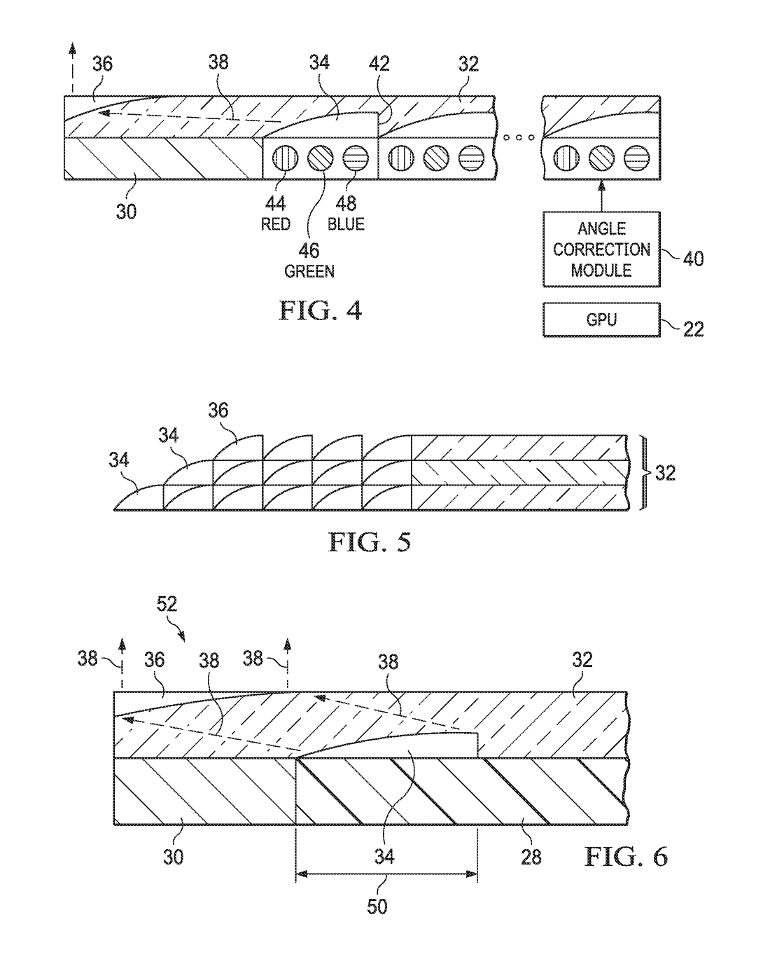

Referring now to FIG. 4, a side view depicts a display 28 having pixels 42 that present visual images with a compressed relative view that expands to an undistorted view at the outer cover 32, in the example embodiment, a flat panel OLED or LCD display 28 generates visual images with red 44, green 46 and blue 48 color elements in each pixel 42. A micro lens 34 redirects light from a generally perpendicular path out of pixel 42 to a generally parallel path over bezel 30 and into micro lens 36. Micro lens 36 redirects the light front the generally parallel path to a perpendicular path out of cover 32 over bezel 30. In one example embodiment, micro lens may be formed in cover 32 for each of plural pixels 42 or for a groups of pixels so that cover 32 coordinates light redirection from a defined position over display 28 to a defined position over bezel 30. An angle correction module 40, such as an embedded code module stored in flash and executable on GPU 22, manages presentation of a blended visual image between the output of display 28 and the visual image presented over bezel 30. For example, a compressed visual image is generated along the perimeter of display 28 and then expanded by the relative position of micro lens 34 and 36 so that the image has an uncompressed presentation over bezel 30. In one embodiment, angle correction module 40 account for refraction effects within the micro lens that alter colors by changing the colors presented at pixels 42 so that a desired color and visual image are presented over bezel 30. For example, if red light emerges laterally from cover 32 at an offset position relative to blue light for the same pixel, angle correction module 40 changes the pixel 42 color values of adjacent pixels to have the visual image appear undistorted over bezel 30.

Referring now to FIG. 5, a multilayer lens structure is depicted to redirect light from display 28 to extend out over a bezel 30. FIG. 5 illustrates that multiple lens of various materials may be stacked and laterally offset to accomplish a desired visual image offset. One goal of multiple stacked lens structures is to provide sufficient visual image lateral offset without introduction of distortion and keeping the thickness of cover 32 to a minimum.

Referring now to FIG. 6, a side view depicts display 28 having a visual image redirected through a first lens 34 to proceed towards a second lens 36 and out of a cover 32 over a bezel 30 with the visual image expanded over the bezel. A pixel area 50 generates a compressed visual image that, once expanded, blends with the image shown on display 28. Lens 34 distributes the light of the compressed visual image to a bezel area 52 disposed over bezel 30. Blending of the visual image may be accomplished with the interaction of lens 34 and 36 so that the compressed visual image expands across bezel area 52 having a greater size than pixel area 50. In one embodiment, lens 34 may be assembled from a series of micro lens with spacing between each other. Pixels 42 located in a spacing provide light on a generally perpendicular path out of cover 32 to present the visual image above display 28 while adjacent pixels 42 aligned with a micro lens provide light towards bezel 30. The angle correction module defines pixel values based upon the view after the light passes through cover 32 so that a blended visual image is presented to an end user over the entirety of cover 32, including the part of cover 32 placed over bezel 30.

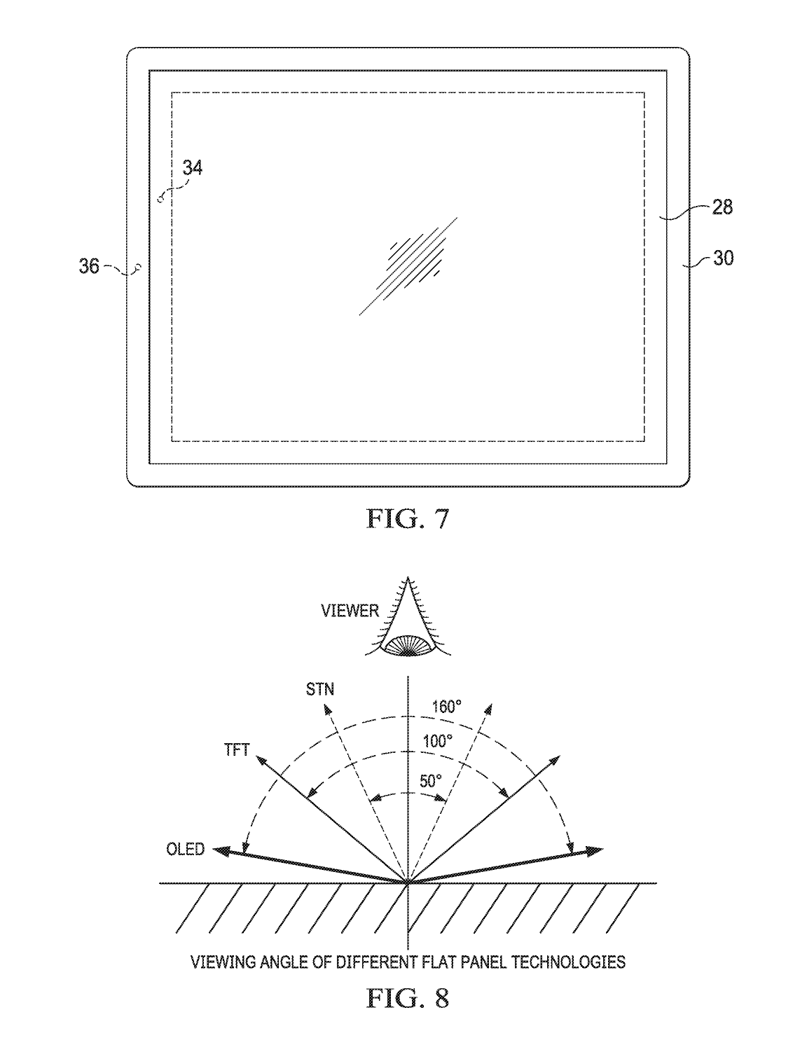

Referring now to FIG. 7, a top view depicts a display 28 having a bezel 30 with a first lens structure 34 disposed over the display 28 at its perimeter and a second lens structure 36 disposed over the bezel 30. In the example embodiment, each lens structure is formed as a line that runs along the perimeter of bezel 30. As depicted in FIGS. 2 and 5, each lens structure may include parallel lines of micro lens integrated in cover 32. The lens may be formed with machining or other manufacture techniques. An end user viewing display 28 sees a visual image that expands beyond the perimeter of display 28 to present a blended visual image over bezel 30.

Referring now to FIG. 8, a side view depicts the available viewing angles typically found with different types of display technologies. Increased viewing angles available with OLED provide a more rich visual presentation. In various embodiments, the inner and outer lens structures provide curved sides to adapt display visual images with different viewing angles for translation to a bezel area. In one example embodiment, pixel density is increased along the perimeter of the display relative to other portions of the display so that image quality and brightness over the bezel blends with the primary display. For example, the compressed visual image is generated along the perimeter of the display with the increased pixel density so that the expanded visual image presented over the bezel has the visual effect of matching the pixel density across the main part of the display. For instance, an OLED film that generates visual images may use greater brightness or be built with greater pixel density along its perimeter or may have a double layer so that pixels stack vertically to create greater brightness and visual quality. As another example, with an LCD flat panel display, a backlight may have greater brightness about the perimeter of the display to provide improved decompression of the visual image across the bezel, such as by adjusting for light loss due to the increase distance traveled to the shifted image location.

In various embodiments, the dual opposing lens structure may be integrated with curves formed in the cover to further adapt the cover for shifting a visual image. For example, the lens structure may include a curved edge with a smaller radius supported by the thin cover thickness so that the curved edge and integrated lens structure cooperate to shift the visual image over the bezel. That is, a more thin cover is available because of the lens structure, but the thinner cover may still provide a curved edge that redirects light so that the integrated lens structure may have a less abrupt prism shape. The cover may be manufactured from glass, plastic or a combined material construction as one piece with micro lens built in the edges or as two or more contiguous pieces fused together and having a lens portion optimized to optically distribute the light laterally. For example the inner and outer lens structures may be built into an insert that couples to a slot of the cover. The different materials may have the angle of refraction and material selected to provide a desired light distribution.

Although the present invention has been described in detail, it should be understood that various changes, substitutions and alterations can be made hereto without departing from the spirit and scope of the invention as defined by the appended claims.

What is claimed is:

1. A portable information handling system comprising:
a housing;
processing components disposed in the housing and operable to process information;
a display integrated in the housing and interfaced with the processing components, the display operable to present information as visual images;
a bezel coupled to the information handling system at a perimeter of the display; and
a cover coupled over the display and bezel, the cover integrating an inner micro lens proximate the display and integrating an outer micro lens distal the display, the inner micro lens redirecting light illuminated from the display towards the outer micro lens, the outer micro lens redirecting the light out of the cover over top of the bezel.

2. The system of claim 1 further comprising:
plural inner micro lens disposed over the display proximate the bezel; and
plural outer micro lens disposed over the bezel, each outer micro lens aligned to redirect light from an inner micro lens out of the cover over the bezel.

3. The system of claim 2 wherein the plural inner micro lens have a first lateral spacing and the plural outer micro lens have a second lateral spacing the second lateral spacing greater than the first lateral spacing.

4. The system of claim 3 further comprising a graphics controller interfaced with the display to generate the visual images, the graphics controller generating a compressed visual image along the display outer perimeter, the compressed visual image expanded over the bezel by the second lateral spacing.

5. The system of claim 2 wherein the display comprises plural pixels and the plural inner micro lens have a spaced disposition so that light illuminated from the pixels proceeds to the cover over the display and to the bezel in an interleaved manner.

6. The system of claim 1 wherein the inner and outer micro lens comprise opposing prisms,

7. The system of claim 1 wherein the information handling system comprises a tablet system having a planar housing and the display integrated at one face of the planar housing.

8. The system of claim 1 wherein the inner and outer micro lens comprise a material having a different refraction index than a material of the cover.

9. The system of claim 8 wherein:
the cover comprises glass; and
the micro lens comprises plastic.

10. A method for presenting visual images at an information handling system, the method comprising:
generating the visual images with a display having plural pixels, a perimeter and a cover;
redirecting light illuminated by at least some of the pixels proximate the perimeter from a first path out of the cover to a second path towards a bezel disposed outside of the perimeter; and
redirecting the light at position over the bezel from the second path to a third path out of the cover and substantially parallel to the first path.

11. The method of claim 10 wherein:
the redirecting light from the first path further comprises redirecting the light with a first micro lens integrated in the cover proximate the display; and
the redirecting light from the second path further comprises redirecting the light with a second micro lens integrated in the cover distal the display.

12. The method of claim 11 wherein the first and second micro lens comprise first and second opposing prisms.

13. The method of claim 11 further comprising:
redirecting the light from the first path with plural micro lens integrated in the cover laterally disposed at the perimeter; and
redirecting the light from the second path with plural micro lens integrated in the cover laterally disposed over the bezel.

14. The method of claim 13 further comprising:
spacing at least some of the plural micro lens apart from each other; and
illuminating light from the display out of the cover along the first path through the spacing without redirecting.

15. The method of claim 14 further comprising:
generating a first visual image at the display with light illuminated through the spacing; and
generating a second visual image at the display with light redirected to the third path, the first and second visual images blending to provide a coordinated visual output at the cover.

16. The method of claim 10 further comprising:
generating a compress visual image at the perimeter; and
uncompressing the visual image though redirecting to the third path.

17. A display comprising:
plural pixels that generate a visual image with light illuminated from each pixel, the pixels generally disposed in a plane;
a bezel disposed about a perimeter of the pixels;
a cover disposed over the plural pixels and the bezel;
a first lens integrated with the cover proximate the plural pixels, the first lens redirecting light proceeding from at least some of the plural pixels generally perpendicular to the plane to proceed generally parallel to the plane; and
a second lens integrated with the cover distal the plural pixels and over the bezel, the second lens redirecting light received from the first lens to proceed generally perpendicular to the plane and out the cover over the bezel.

18. The display of claim 17 wherein the first and second lens comprises first and second prisms.

19. The display of claim 17 wherein the first lens comprises a plurality of lens disposed in the plane in plural rows about the perimeter and the second lens comprises a plurality of lens disposed in plural rows over the bezel.

20. The display of claim 17 wherein the first and second lens cooperate to expand a visual image generated by the pixels to a greater surface area over the bezel.
